(19) United States
(12) Patent Application Publication
(10) Pub. No.: US 2014/0119087 A1
(43) Pub. Date: May 1, 2014

(54) POWER CONVERTER

(71) Applicant: DENSO CORPORATION, Kariya-city (JP)

(72) Inventors: Tetsuya MATSUOKA, Kariya-shi (JP); Hiromi ICHIJO, Chiryu-shi (JP); Naoki HIRASAWA, Okazaki-shi (JP)

(73) Assignee: DENSO CORPORATION, Kariya-city (JP)

(21) Appl. No.: 14/068,271

(22) Filed: Oct. 31, 2013

(30) Foreign Application Priority Data
Oct. 31, 2012 (JP) 2012-240388

(51) Int. Cl. H02M 7/5387

(52) U.S. Cl. CPC H02M 7/53871
USPC 363/132

(57) ABSTRACT

A power converter including a plurality of semiconductor modules each having a body including semiconductor elements, where the body is provided with control terminals, a pair of input terminals, and at least two output terminals protruding from the body. The output terminals protruding from the bodies of the respective semiconductor modules are grouped into a plurality of output terminal groups each formed of three output terminals belonging to at least two different semiconductor modules. The power converter further includes a control circuit board electrically connected to the control terminals and configured to turn on and off the respective semiconductor elements of the respective semiconductor modules so as to convert a DC voltage applied to the pair of input terminals of each semiconductor module into a three-phase AC voltage to be outputted from each output terminal group.

### CROSS-REFERENCE TO RELATED APPLICATION

This application is based on and claims the benefit of priority from earlier Japanese Patent Application No. 2012-240388 filed Oct. 31, 2012, the description of which is incorporated herein by reference.

### BACKGROUND

1. Technical Field

The present invention relates to a power converter including a plurality of semiconductor modules each formed of semiconductor elements.

2. Related Art

A known power converter operable to convert direct-current (DC) power/alternating-current (AC) power into AC power/DC power, as disclosed in Japanese Patent Application Laid-Open Publication No. 2010-41809, includes a plurality of semiconductor modules each formed of semiconductor elements, such as insulated-gate bipolar transistors (IGBTs), and a control circuit board that controls the operation of each semiconductor element.

Each semiconductor module has a body including the semiconductor elements, from which control terminals, a pair of input terminals, and three output terminals protrude. A DC voltage is applied to the input terminals. The control terminals are connected to the control circuit board, which turns on and off the respective semiconductor elements of the respective semiconductor modules so as to convert a DC voltage applied to the input terminals into a three-phase AC voltage to be outputted from the output terminals.

The three output terminals of each semiconductor module are connected to an AC load, such as a three-phase AC motor, via bus bars or connectors or the like.

The three output terminals of each semiconductor module form one individual output terminal group, via which the three-phase AC voltage is outputted from the semiconductor module to the AC load. The power converter therefore includes a plurality of such output terminal groups for the respective semiconductor modules.

In the disclosed power converter, however, for each output terminal group, a combination of the three output terminals forming the output terminal group is predefined, that is, the three output terminals forming the output terminal group belong to a corresponding one of the plurality of semiconductor modules. This may require long bus bars to connect to the respective output terminals of each semiconductor module, which may cause the bus bars to interfere with each other. In addition, when connectors are directly connected to the respective output terminals of each semiconductor module, the connectors may be in close proximity to each other, which may cause the connectors to interfere with each other.

In consideration of the foregoing, it would therefore be desirable to have a power converter capable of preventing bus bars or connectors or the like connected to output terminals of respective output terminal groups from electrically interfering with each other.

### SUMMARY

In accordance with an exemplary embodiment of the present invention, there is provided a power converter including: a plurality of semiconductor modules each having a body including semiconductor elements, the body being provided with control terminals, a pair of input terminals, and at least two output terminals protruding from the body, wherein the output terminals protruding from the bodies of the respective semiconductor modules are grouped into a plurality of output terminal groups each formed of three output terminals belonging to at least two different semiconductor modules; and a control circuit board electrically connected to the control terminals protruding from the bodies of the respective semiconductor modules and configured to turn on and off the respective semiconductor elements of the respective semiconductor modules so as to convert a DC voltage applied to the pair of input terminals of each semiconductor module into a three-phase AC voltage to be outputted from the three output terminals of each output terminal group.

In the power converter configured as above, for each of the plurality of output terminal groups, the three output terminals of the output terminal group belong to at least two different semiconductor modules. For example, two of the three output terminals of the output terminal group belong to a first semiconductor module, and one of the three output terminals of the output terminal group belongs to a second semiconductor module.

This can enhance the versatility of combinations of three output terminals to form one individual output terminal group. This may thus lead to an optimal combination of three output terminals depending on a shape and/or position of each bus bar such that the output terminals forming one individual output terminal group are in close proximity to each other so that long bus bars are not needed.

The present invention can therefor provide a power converter capable of preventing bus bars or connectors connected to the respective output terminals of the respective output terminal groups from interfering with each other.

### BRIEF DESCRIPTION OF THE DRAWINGS

In the accompanying drawings:

FIG. 1 is an enlarged perspective view showing a main portion of a power converter in accordance with a first embodiment of the present invention;

FIG. 2 is a perspective view of the power converter of the first embodiment;

FIG. 3 is a top view of each semiconductor module of the first embodiment;

FIG. 4 is a top view of a boost module of the first embodiment;

FIG. 5 is a perspective view of a reactor of the first embodiment;

FIG. 6 is a top view of the power converter of the first embodiment having bus bars removed;

FIG. 7 is a sectional view taken along line VII-VII of FIG. 6;

FIG. 8 is a sectional view taken along line VIII-VIII of FIG. 6;

FIG. 9 is a sectional view taken along line IX-IX of FIG. 6;

FIG. 10 is a circuit diagram of the power converter of the first embodiment;

FIG. 11 is a schematic diagram of a power converter in accordance with a second embodiment of the present invention;

FIG. 12 is a schematic diagram of a power converter in accordance with a third embodiment of the present invention;

FIG. 13 is a schematic diagram of a power converter in accordance with a fourth embodiment of the present invention;

FIG. 14 is a schematic diagram of a power converter in accordance with a fifth embodiment of the present invention;

FIG. 15 is a schematic diagram of a power converter in accordance with a sixth embodiment of the present invention; and

FIG. 16 is a perspective view of an example of comparative power converter.

### DESCRIPTION OF SPECIFIC EMBODIMENTS

The present invention will now be described more fully hereinafter with reference to the accompanying drawings. The terms “connecting” and “being connected” refer to electrically connecting and being electrically connected, respectively, except where specified otherwise.

### First Embodiment

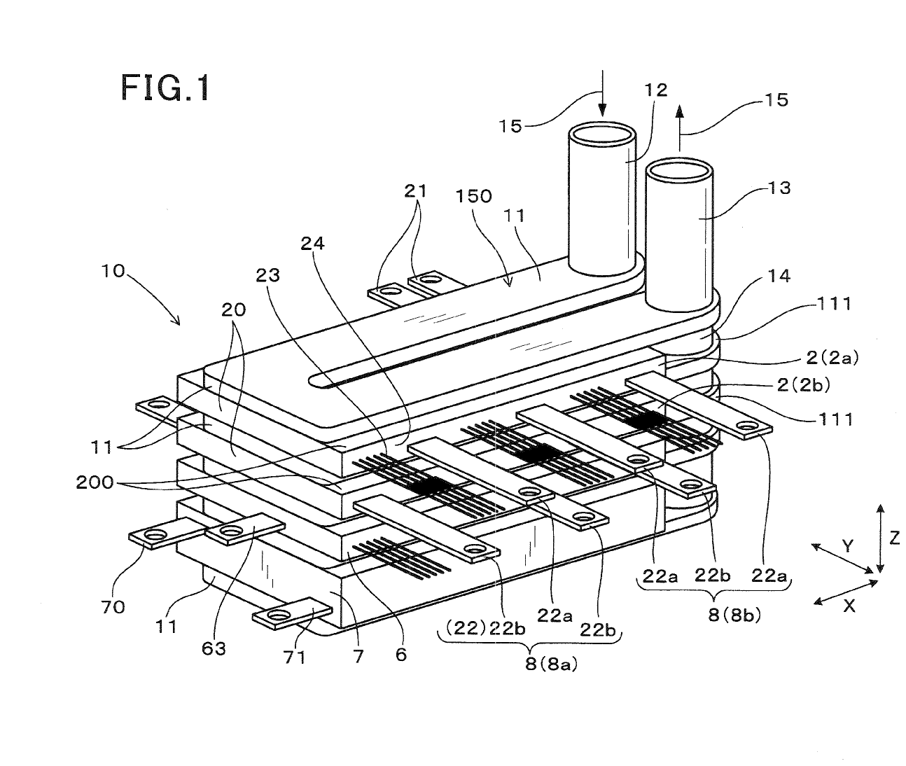

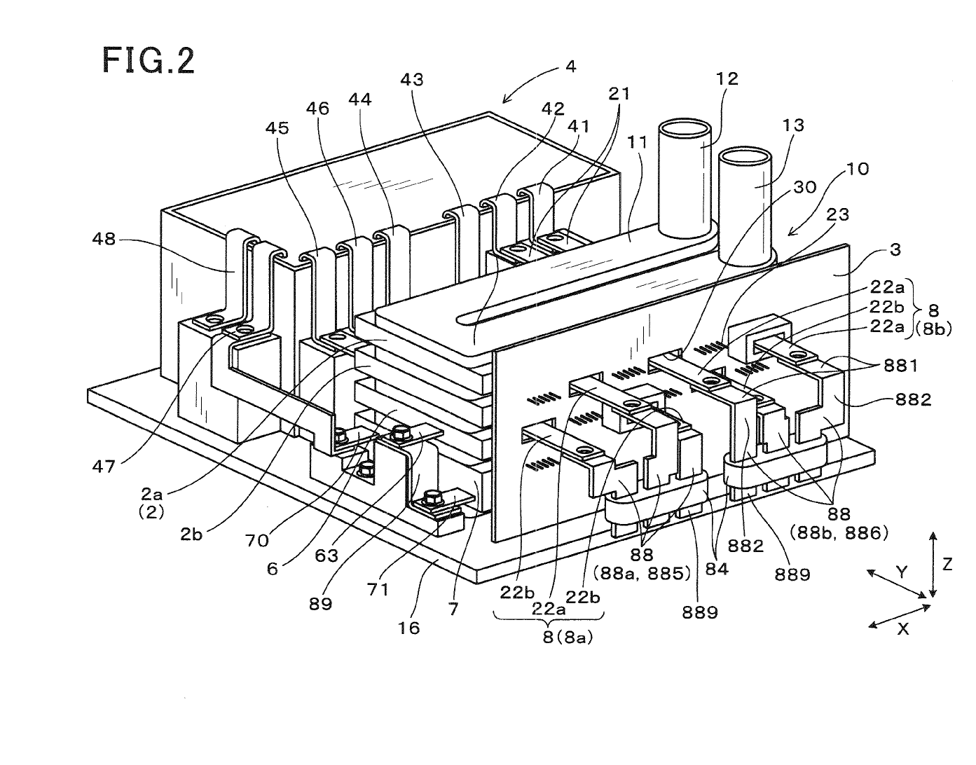

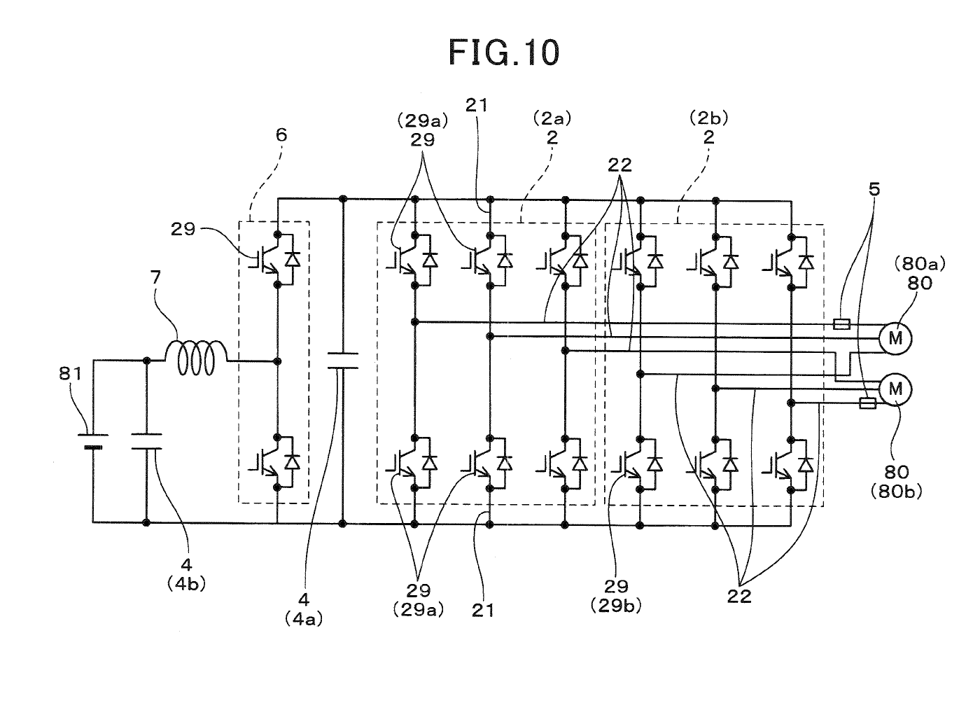

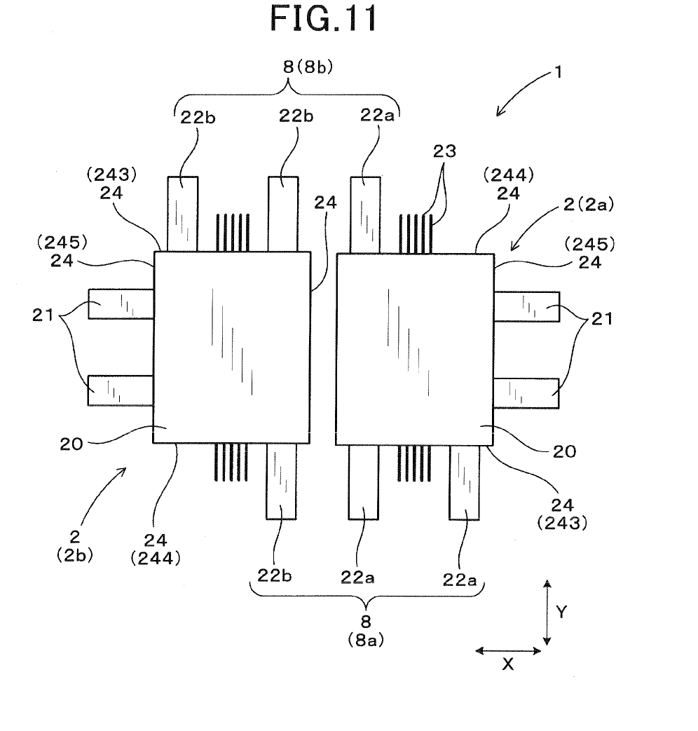

There will now be explained a power converter in accordance with a first embodiment of the present invention with reference to FIGS. 1 to 10. The power converter 1 of the present embodiment, as shown in FIGS. 1, 2, includes a plurality of semiconductor modules 2 (2a, 2b) and a control circuit board 3. Each semiconductor module 2 has a body 20 including semiconductor elements 29 (see FIG. 10), where control terminals 23, a pair of input terminals 21 to which a DC voltage is applied, and three output terminals 22 (22a, 22b) protrude from the body 20. The control terminals 23 are connected to the control circuit board 3 that is configured to turn on and off the respective semiconductor elements 29 of the respective semiconductor modules 2 so as to convert a DC voltage applied to the input terminals 21 into a three-phase AC voltage to be outputted from the output terminals 22.

A total of six output terminals are grouped into two groups 8, where each group has three output terminals 22, via which a three-phase AC voltage is outputted from the power converter 1. Each group of output terminals 8 (8a, 8b) are connected to a corresponding AC load 80 (see FIG. 10). A group of output terminals may hereinafter be referred to as an output terminal group.

Each semiconductor module 2 has three output terminals 22. A first one of the two output terminal groups includes one output terminal 22a of the semiconductor module 2a and two output terminals 22b of the semiconductor module 2b. A second one of the two groups includes two output terminals 22a of the semiconductor module 2a and one output terminal 22b of the semiconductor module 2b.

The power converter 1 is a vehicle-mounted inverter, which is a stack 10 of the two semiconductor modules 2 (2a, 2b), a boost module 6, a reactor 7, and a plurality of cooling elements 11, as shown in FIG. 1. The cooling elements 11 are configured to cool the semiconductor modules 2, the boost module 6, and the reactor 7.

As shown in FIG. 10, each semiconductor module 2 includes six semiconductor elements 29 (IGBTs). The semiconductor elements 29 form a three-phase bridge circuit. The boost module 6 includes two semiconductor elements 29. In the present embodiment, a DC voltage of a DC power supply 81 is boosted by the boost module 6 and the reactor 7. The boosted DC voltage is smoothed by a smoothing capacitor 4a. The smoothed boosted DC voltage is converted into a three-phase AC voltage by turning on and off the respective semiconductor elements 29 of the semiconductor module 2.

In the present embodiment, a three-phase AC voltage for driving a first AC load 80a, e.g., a three-phase AC motor, is generated by four semiconductor elements 29a included in the semiconductor module 2a and two semiconductor elements 29b included in the semiconductor module 2b. A three-phase AC voltage for driving a second AC load 80b is generated by two semiconductor elements 29a included in the semiconductor module 2a and four semiconductor elements 29b included in the semiconductor module 2b.

As shown in FIG. 2, a capacitor 4 is provided on the side opposite the protruding output terminals 22. The capacitor 4 includes the smoothing capacitor 4a and a noise subtraction filter capacitor 4b (see FIG. 10).

In addition, as shown in FIG. 2, the control circuit board 3 is provided adjacent the stack 10. The control circuit board 3 includes a plurality of through-holes 30, through which the respective output terminals 22 pass, and is connected to the control terminals 23. The control circuit board 3 controls the switching operation of each semiconductor element 29.

Current sensors 5 are attached to some of the output terminals 22 to detect current values. The detected current values are fed to the control circuit board 3. The control circuit board 3 uses the detected current values to control the operations of the semiconductor modules 2.

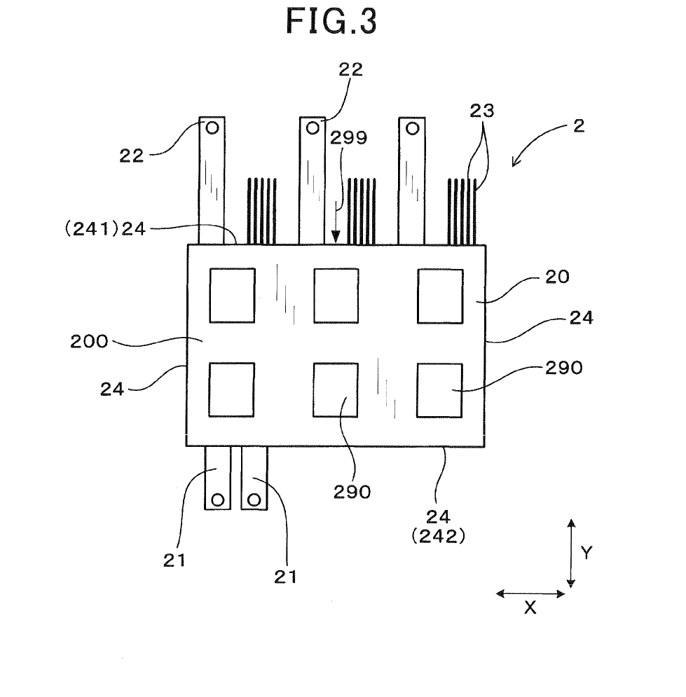

As shown in FIG. 3, the body 20 of each semiconductor module 2 is rectangular plate-shaped. The control terminals 23 and the three output terminals 22 protrude in the same direction (Y-direction). A Y-directional length of the control terminals 23 is less than a Y-directional length of the output terminals 22. The input terminals 21 protrude from the body 20 on the side opposite the output terminals 22 and control terminals 23. The output terminals 22 protrude from a side surface 241 of the body 20 and the input terminals 21 protrude from the opposite side surface 242, where the side surfaces 241, 242 include longer edges of the body 20. In addition, a heatsink 290 is exposed on a principal surface 200 of the body 20 for heat dissipation from the semiconductor modules 2. The term “principal surface” of the body 20 means a surface having the greatest surface area among the six surfaces of the body 20. The term “side surface” of the body 20 means a surface other than the principal surface.

As shown in FIGS. 1, 3, the three output terminals 22 are spaced apart from each other by a predetermined spacing along a direction (X-direction) perpendicular to both a normal direction of the principal surface 200 of the body 20 (Z-direction) and a protruding direction of the output terminals 22 (Y-direction). The three output terminals 22 are not bilaterally symmetric about the center 299 of the side surface 241 along the X-direction, but are slightly displaced in the X-direction. In addition, the pair of input terminals 21 are shifted toward one side of the side surface 242 along the X-direction.

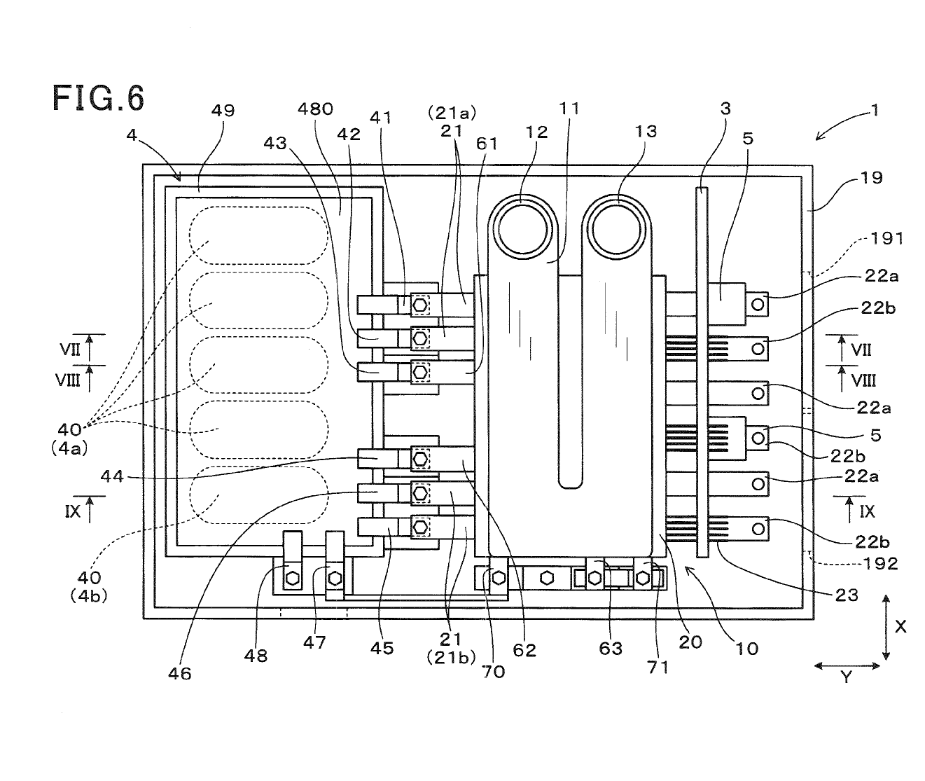

As shown in FIG. 1, the two semiconductor modules 2a, 2b are identically shaped. The semiconductor module 2b is turned upside down with respect to the semiconductor module 2a. As shown in FIG. 6, when viewed from the Z-direction, none of the three output terminals of the semiconductor module 2a overlap any of the three output terminals of the semiconductor module 2b. More specifically, when viewed from the Z-direction, the three output terminals of the semiconductor module 2a and the three output terminals of the semiconductor module 2b are alternately disposed along the X-direction without overlapping each other.

In addition, as shown in FIG. 2, the output terminals 22 are connected to bus bars 88. Each bus bar 88 includes a first portion 881 being connected to a corresponding output terminal 22 and extending in the Y-direction, and a second portion 882 being connected to the first portion 881 and extending in the Z-direction. A leading end 889 of the second portion 882 is connected to a connector (not shown). Three such bus bars 88 connected to the respective output terminals 22 forming the first output terminal group 8a are bound together by a binder 84 to form a first bus bar group 885. Similarly, three such bus bars 88 connected to the respective output terminals 22 forming the second output terminal group 8b are bound together by a binder 84 to form a second bus bar group 886.

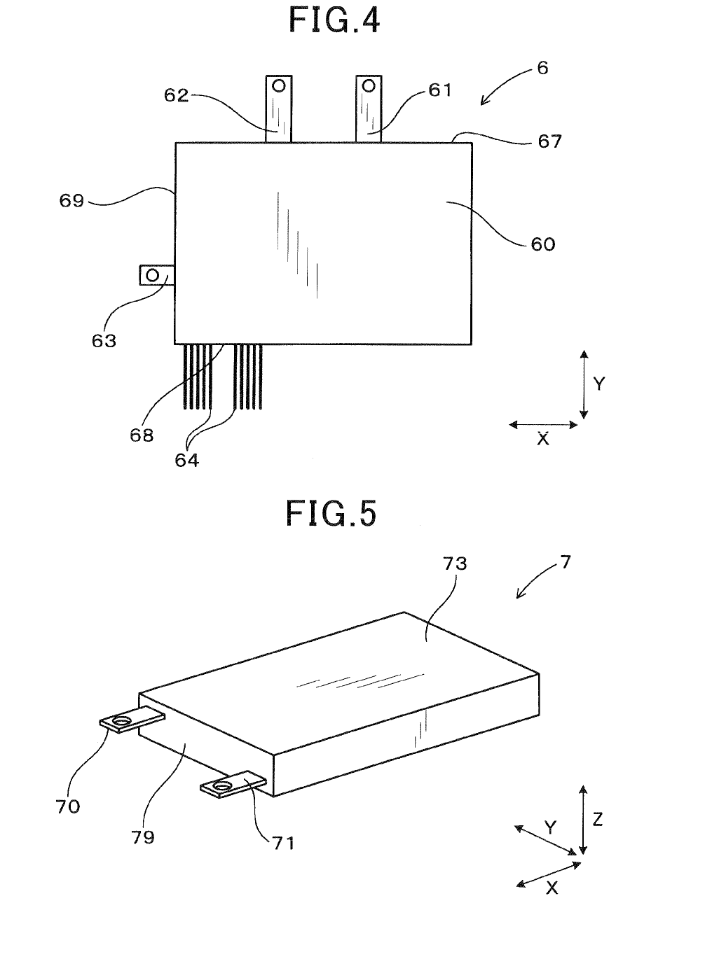

The boost module 6, as shown in FIG. 4, includes a rectangular plate-shaped body 60, a reactor connection terminal 63, a positive terminal 61, a negative terminal 62, and control terminals 64. The positive terminal 61 and the negative terminal 62 protrude from a first side surface 67 of the body 60.

The control terminals 64 protrude from a second side surface 68 opposite the side surface 67. The control terminals 64 are connected to the control circuit board 3.

The reactor connection terminal 63 is provided on a third side surface 69 perpendicular to the first side surface 67.

A shown in FIG. 5, the reactor 7 includes a rectangular plate-shaped body 73 and two terminals 70, 71 protruding from a side surface 79 of the body 73 in the X-direction.

The terminals 70, 71 of the reactor 7 and the reactor connection terminal 63 of the boost module 6 protrude from the respective side surfaces 79, 69 in the same direction (X-direction). As shown in FIG. 2, the reactor connection terminal 63 and one of the terminals (terminal 71) of the reactor 7 are connected to each other via a connecting member 89. The other one of the terminals (terminal 70) of the reactor 7 is connected to a positive input terminal 47 of the capacitor 4.

As shown in FIG. 1, the power converter 1 includes the plurality of cooling elements 11, each of which is a U-shaped tube and provides a coolant flow path 150 through which a coolant 15 flows in the cooling element. The cooling elements are connected in parallel with each other via links 14 at leading portions 111 of the respective cooling elements. The plurality of cooling elements 11 are provided with an inlet line 12 for introducing the coolant 15 into the cooling elements and an outlet line 13 for exhausting the coolant 15 from the cooling elements. The coolant 15 introduced via the inlet line 12 flows through the coolant flow paths 150 of the respective cooling elements and the links 14 connecting the cooling elements and is exhausted from the cooling elements via the outlet line 13. With this configuration, the cooling elements 11 can efficiently cool the semiconductor modules 2, the boost module 6, and the reactor 7.

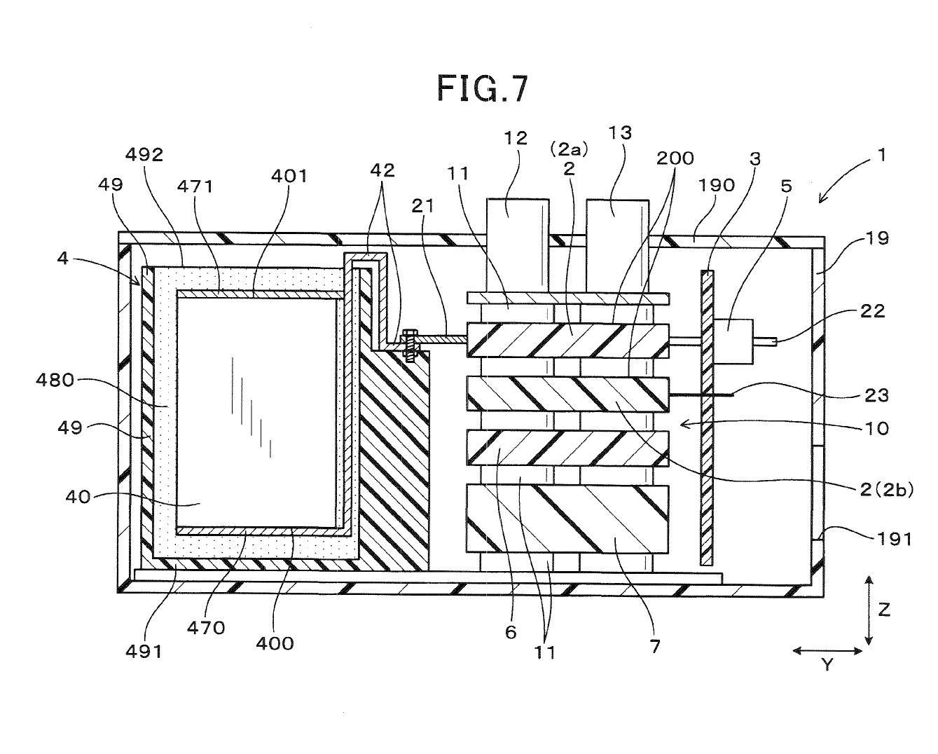

As shown in FIGS. 6, 7, the capacitor 4 includes a capacitor casing 49, a plurality of capacitor elements 40 within the capacitor casing 49, and a sealing member 480 for sealing the capacitor elements 40 in the capacitor casing 49. Some of the capacitor elements 40 are the smoothing capacitors 4a (see FIG. 10). The others are the filter capacitors 4b.

As shown in FIG. 7, a casing bottom 491 side end face of the capacitor element 40 serves as a negative electrode 400, and a casing opening 492 side end face 401 serves as a positive electrode 401. The negative electrode 400 is connected to a negative electrode plate 470, and the positive electrode 401 is connected to a positive electrode plate 471. The negative electrode plate 470 is connected to the negative electrodes 400 of the respective capacitor elements 40, while the positive electrode plate 471 is only connected to the capacitor elements 40 for the smoothing capacitors 4a.

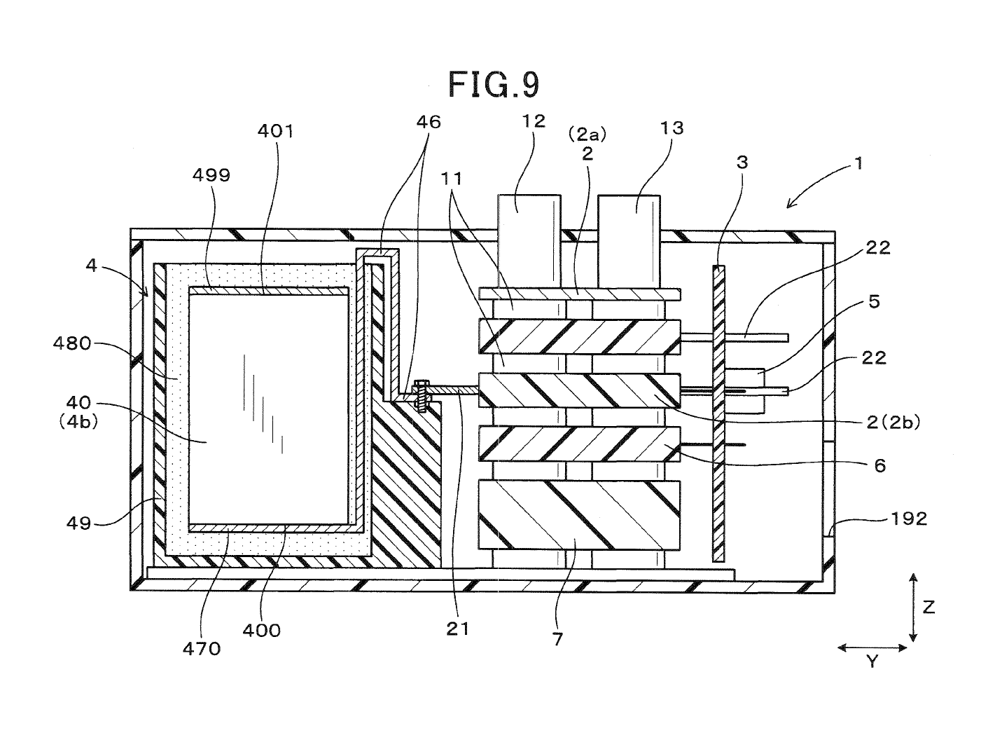

Negative terminals 42, 44, 46 and a negative input terminal 48 (see FIG. 6) are connected to the negative electrode plate 470. These terminals 42, 44, 46, 48 extend from the inside to the outside of the casing 49 through the casing opening 492. Positive terminals 41, 43, 45 (see FIG. 6) are connected to the positive electrode plate 471. Meanwhile, the positive electrode 401 of the capacitor element 40 for the filter capacitor 4b is connected to another electrode plate 499 (see FIG. 9). A positive input terminal 47 (see FIG. 6) is connected to the electrode plate 499.

As shown in FIGS. 6, 7, the two terminals 41, 42 of the six terminals 41 to 46 of the capacitor 4 disposed along the X-direction are connected to the input terminals 21a of the semiconductor module 2a, where the two terminals 41, 42 are distant from the input terminals 47, 48 in the X-direction.

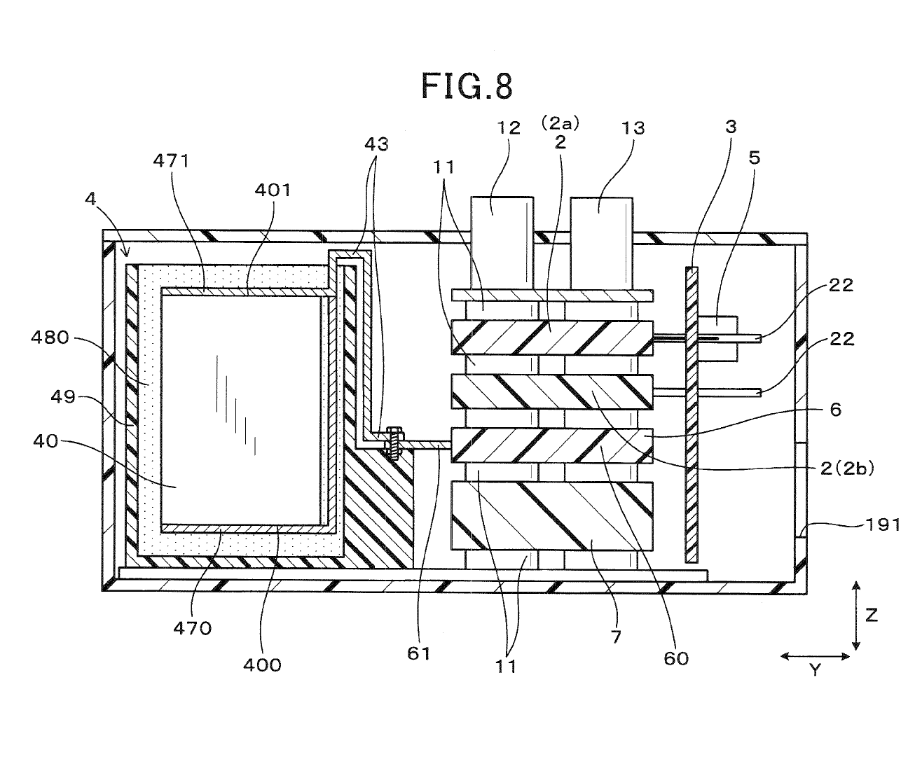

As shown in FIGS. 6, 8, the two intermediate terminals 43, 44 of the six terminals 41 to 46 of the capacitor 4 disposed along the X-direction are connected to the terminals 61, 62 of the boost module 6.

As shown in FIGS. 6, 9, the two terminals 45, 46 of the six terminals 41 to 46 of the capacitor 4 disposed along the X-direction are connected to the input terminals 21b of the semiconductor module 2b, where the two terminals 45, 46 are close to the input terminals 47, 48 in the X-direction.

In addition, as shown in FIG. 6, the casing 19 includes output connector insertion holes 191, 192. Output connectors (not shown) are set in the output connector insertion holes 191, 192 to be connected to the bus bars 88 (see FIG. 2) inside of the casing 19. The output terminals 22 are connected to the respective AC loads 80 (see FIG. 10) via the output connectors.

There will now be explained some advantages of the present embodiment. As shown in FIGS. 1, 2, one of the three output terminals 22a of the semiconductor module 2a and two of the three output terminals 22b of the semiconductor module 2b form a first output terminal group 8a. Two of the three output terminals 22a of the semiconductor module 2a and one of the three output terminals 22b of the semiconductor module 2b form a second output terminal group 8b.

This configuration can enhance the versatility of combinations of three output terminals to form one individual output terminal group 8. This may thus lead to an optimal combination of three output terminals 22 depending on a geometry and/or position of each bus bar 88 such that the three output terminals 22 forming one individual output terminal group 8 are in close proximity to each other so that long bus bars 88 are not needed.

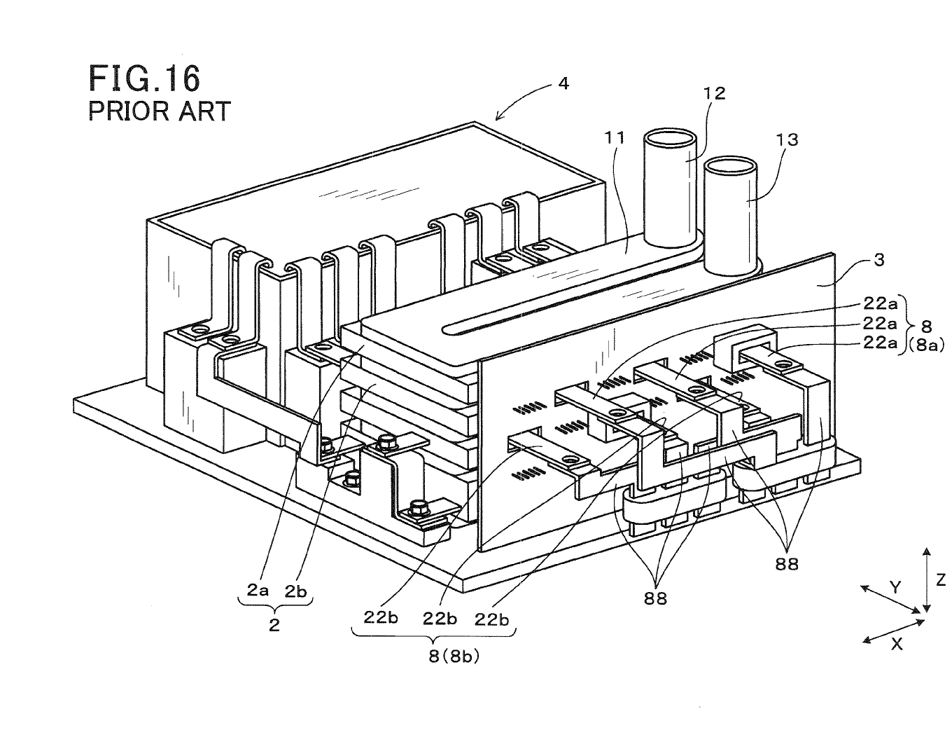

One can imagine an embodiment such that the three output terminals of the semiconductor module 2a form a first output terminal group and the three output terminals of the semiconductor module 2b form a second output terminal group, as shown in FIG. 16. Such an embodiment may require long bus bars to connect the output terminals and the connectors depending on positions of the respective output terminals, which may cause some of the bus bars to be in contact with each other. The present embodiment, as shown in FIG. 2, leads to a combination of three output terminals that form one individual output terminal group 8 without use of long bus bars.

In the present embodiment, as shown in FIGS. 1, 2, the stack 10 of the plurality of semiconductor modules 2 and the plurality of cooling elements are provided. The plurality of output terminals 22 protrude in the same direction (Y-direction) from side surfaces 24 of the bodies 20 of the respective semiconductor modules 2. In addition, three of the plurality of output terminals 22, which are in close proximity to each other in the X-direction, form one individual output terminal group.

The plurality of output terminals 22 included in each semiconductor module 2 are distributed in the X-direction. Accordingly, in such an embodiment as shown in FIG. 16 where the three output terminals of the semiconductor module 2a form one output terminal group 8a and the three output terminals of the semiconductor module 2b form another output terminal group 8b, the three output terminals in each output terminal group are distributed in the X-direction.

Given a stack of a plurality of semiconductor modules 2 (2a, 2b) and a plurality of cooling elements as shown in FIG. 16, three output terminals of the semiconductor module 2a that are distributed in the X-direction and form one output terminal group 8a and three output terminals of the semiconductor module 2b (adjacent the semiconductor module 2a in the Z-direction) that are distributed in the X-direction and form another output terminal group 8b are in close proximity to each other in the Z-direction. Such a configuration requires bus bars to be long enough to connect to the three respective output terminals of each semiconductor module that are disposed in the X-direction. In addition, since the output terminals of the output terminal group 8a and the output terminals of the output terminal group 8b are disposed in close proximity to each other in the Z-direction, the bus bars 88 are more susceptible to interference with each other.

In the present embodiment, as shown in FIG. 2, each output terminal group 8 is formed by three output terminals, some of which belong to the semiconductor module 2a and the others belong to the semiconductor module 2b, so that the three output terminals of each output terminal group 8 can be disposed in close proximity to each other in the X-direction. This can prevent three output terminals 22 of each output terminal group 8 from being distributed in the X-direction and the output terminals of different output terminal groups 8 from being disposed in close proximity to each other in the Z-direction, which can prevent the bus bars 88 connected to the respective output terminals 22 from electrically interfering with each other.

In the present embodiment, as shown in FIG. 6, none of the output terminals 22a protruding from the body 20 of the semiconductor module 2a overlap any of the output terminals 22b protruding from the body 20 of the semiconductor module 2b (adjacent the semiconductor module 2a in the Z-direction) when viewed from the Z-direction. Since each of the output terminals 22 (22a, 22b) of each of the semiconductor modules 2a, 2b is welded to a corresponding bus bar 8 after overlapping leading portions of the output terminal and the bus bar in the Z-direction, this can facilitate connecting (e.g., welding) the output terminals and the bus bars.

In the present embodiment, the output terminals 22 are connected to the bus bars 88. The bus bars 88 are connected to the connectors. Alternatively, the output terminals 22 may be connected directly to the connectors without using the bus bars 88.

As described above, the present embodiment can provide a power converter capable of preventing bus bars and/or connectors or the like connected to the respective output terminal groups from interfering with each other.

### Second Embodiment

There will now be explained a second embodiment of the present invention. Only differences of the second embodiment from the first embodiment will be explained. Elements having the same functions as in the first embodiment are assigned the same numbers and will not be described again for brevity.

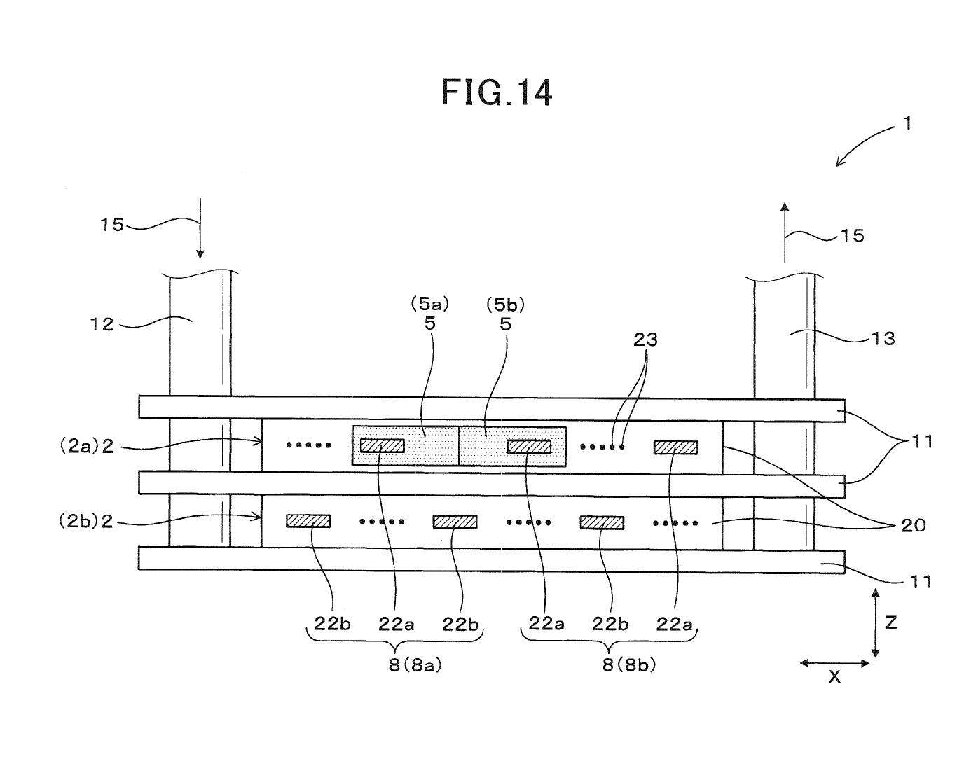

In the present embodiment, the semiconductor modules 2 of a power converter 1 are modified in shape and arrangement. As shown in FIG. 14, each semiconductor module 2 of the present embodiment includes a quadrilateral plate-shaped body 20, from which control terminals 23, a pair of input terminals 21, and three output terminals 22 protrude. In each semiconductor module 2, two of the three output terminals 22 protrude from a first side surface 243 of the body 20, and the other one protrudes from a second side surface 244 opposite and parallel to the first side surface 243. The pair of input terminals 21 protrude from a third side surface 245 perpendicular to both the first and second side surfaces 243, 244.

The power converter 1 of the present embodiment includes two semiconductor modules 2 (2a, 2b) having identical bodies and being disposed adjacent each other. The pair of input terminals 21 of the semiconductor module 2a and the pair of input terminals 21 of the semiconductor module 2b protrude in opposite directions from the respective bodies 20. Two output terminals 22a on a first side surface 243 of the semiconductor module 2a and one output terminal 22b on a second side surface 244 of the semiconductor module 2b protrude from the respective bodies 20 in the same direction and form a first output terminal group 8a for outputting a three-phase AC voltage.

In addition, one output terminal 22a on a second side surface 244 of the semiconductor module 2a and two output terminals 22b on a first side surface 243 of the semiconductor module 2b protrude from the respective bodies 20 in the same direction and form a second output terminal group 8b for outputting a three-phase AC voltage.

Some advantages of the present embodiment will now be explained. In the above configuration, the three output terminals of the semiconductor module 2a and the three output terminals of the semiconductor module 2a lie opposite each other. This can prevent bus bars connected to the output terminals of the respective output terminal groups 8a, 8b from inferring with each other.

In addition, since at most two output terminals 22 protrude from one of side surfaces 24 of each semiconductor module 2a, 2b, an X-directional length of the body 20 of each semiconductor module 2a, 2b can be reduced as compared with the first embodiment where the three terminals protrude from one of the side surfaces 24 of each semiconductor module 2a, 2b. This can facilitate downsizing of the semiconductor modules 2.

### Third Embodiment

There will now be explained a third embodiment of the present invention. Only differences of the third embodiment from the first embodiment will be explained. Elements having the same functions as in the first embodiment are assigned the same numbers and will not be described again for brevity.

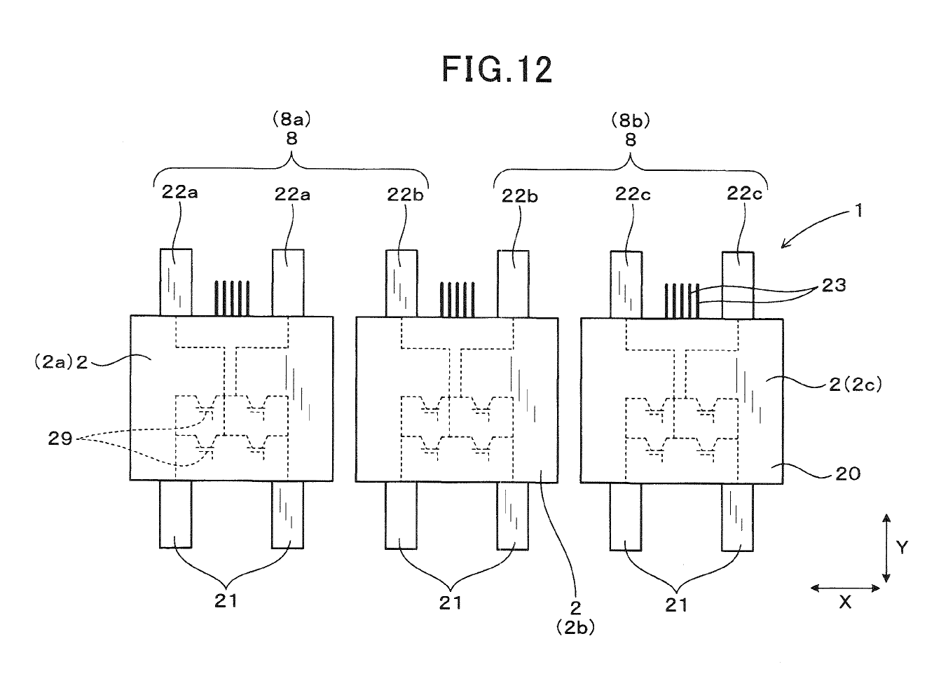

In the present embodiment, the semiconductor modules 2 of a power converter 1 of the present embodiment are modified in shape and arrangement. As shown in FIG. 12, the power converter 1 includes three semiconductor modules 2, where each semiconductor module 2 has two input terminals 21 and two output terminals 22. A body 20 of each semiconductor module 2 includes four semiconductor elements 29 (IGBTs) forming a bridge circuit.

In the present embodiment, the three semiconductor modules 2 are disposed in series along the X-direction. The output terminals of the three respective semiconductor modules 2 protrude in the same direction (e.g., in the Y-direction as shown in the FIG. 12). The two output terminals 22a of a first semiconductor module 2a and one of the two output terminals 22b of a second semiconductor module 2b form a first output terminal group 8a. The other one of the two output terminals 22b of the second semiconductor module 2b and the two output terminals 22c of a third semiconductor module 2c form a second output terminal group 8b.

Some advantages of the present embodiment will now be explained. In the above configuration, the first output terminal group 8a is disposed adjacent the second output terminal group 8b along the X-direction. This allows the two output terminal groups 8a, 8b to be spaced apart from each other by an adequate spacing, which can prevent bus bars connected to the output terminals of the respective output terminal groups 8a, 8b from inferring with each other.

In addition, in the present embodiment, each semiconductor module 2 includes only four semiconductor elements 29 (IGBTs). This can enhance fabrication yield in producing the semiconductor modules 2 as compared with embodiments where each semiconductor module 2 includes six or more semiconductor elements 29 (IGBTs).

### Fourth Embodiment

There will now be explained a fourth embodiment of the present invention. Only differences of the fourth embodiment from the first embodiment will be explained. Elements having the same functions as in the first embodiment are assigned the same numbers and will not be described again for brevity.

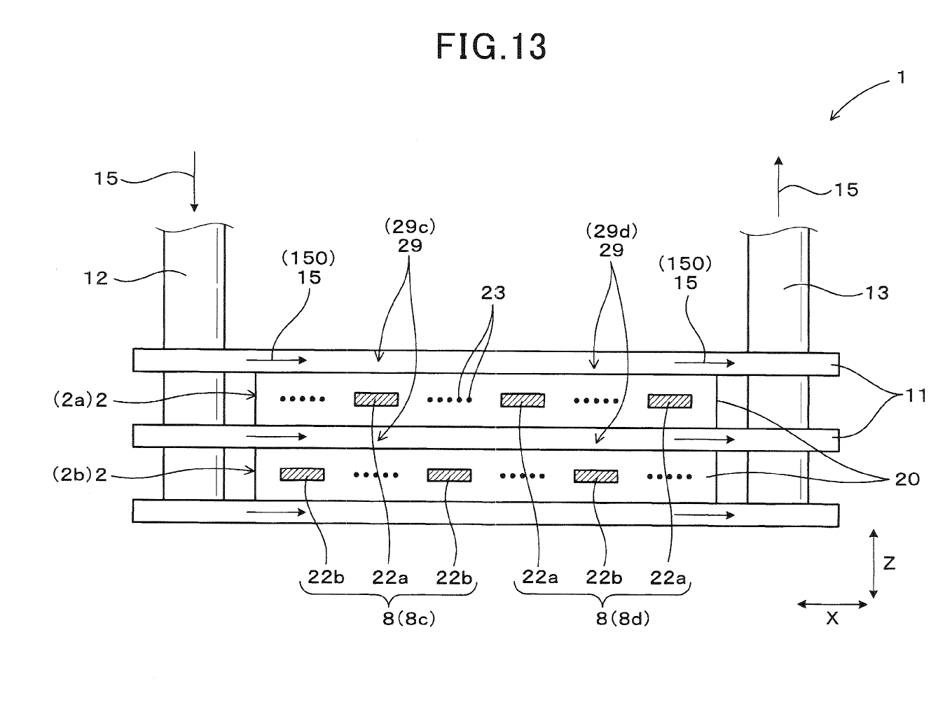

In the present embodiment, the cooling elements 11 are modified in configuration. As shown in FIG. 13, the coolant 15 flows through the coolant flow path 150 in each cooling element 11 extending from the inlet line 12 to the outlet line 13 along the X-direction. As in the first embodiment, all the output terminals are grouped into two output terminal groups 8 (8c, 8d), where the three output terminals of a first output terminal group 8c are connected to a first AC load 80 which has a relatively high power consumption and the three output terminals of a second output terminal groups 8d are connected to a second AC load 80 which has a relatively low power consumption (see FIG. 10). The output terminals of the output terminal group 8c are connected to an AC load 80.

As in the first embodiment, the body 20 of each semiconductor module 2 includes six semiconductor elements 29 (IGBTs) (see FIG. 10). Some of the twelve semiconductor elements 29 (six elements of the semiconductor module 2a plus six elements of the semiconductor module 2b) are high power semiconductor elements 29c that output a three-phase. AC voltage to a high output terminal group 8c. The others of the twelve semiconductor elements 29 are low power semiconductor elements 29d that output a three-phase AC voltage to a low output terminal group 8d. The high power semiconductor elements 29c are disposed upstream of the low power semiconductor elements 29d along the coolant flow path 150.

With this configuration, since the high power semiconductor elements 29c consume more power than the lower semiconductor element 29d, the coolant of lower temperature can be used to cool the high power semiconductor elements 29c. This can enhance efficiency of cooling the high power semiconductor elements 29c.

### Fifth Embodiment

There will now be explained a fifth embodiment of the present invention. Only differences of the fifth embodiment from the first embodiment will be explained. Elements having the same functions as in the first embodiment are assigned the same numbers and will not be described again for brevity.

In the present embodiment, the current sensors 5 are modified in configuration. As shown in FIG. 14, the power converter 1 includes two current sensors 5, i.e., first and second current sensor 5a, 5b. The first current sensor 5a measures a current flowing into the three output terminals 22 forming a first output terminal group 8a. The second current sensor 5b measures a current flowing into the three output terminals 22 forming a second output terminal group 8b. The two current sensors 5a, 5b are connected to a control circuit board (not shown). The control circuit board uses the current values measured by the current sensors 5a, 5b to control the operations of semiconductor modules 2.

The output terminal 22 to which the first current sensor 5a is attached and the output terminal 22 to which the second current sensor 5b is attached protrude from the same body 20 of either one of the semiconductor modules 2 (e.g., the body 20 of the semiconductor modules 2a as shown in FIG. 14). The first and second current sensors 5a, 5b are integrated.

This can reduce the total number of components, which leads to reduction of manufacturing costs. In addition, the two output terminals to which the respective current sensors 5 are attached protrude from the same body 20 of either one of the semiconductor modules 2. This allows the two output terminals to be disposed in close proximity to each other, which facilitates attachment of the current sensor 5a, 5b in an integrated manner.

### Sixth Embodiment

There will now be explained a sixth embodiment of the present invention. Only differences of the sixth embodiment from the first embodiment will be explained. Elements having the same functions as in the first embodiment are assigned the same numbers and will not be described again for brevity.

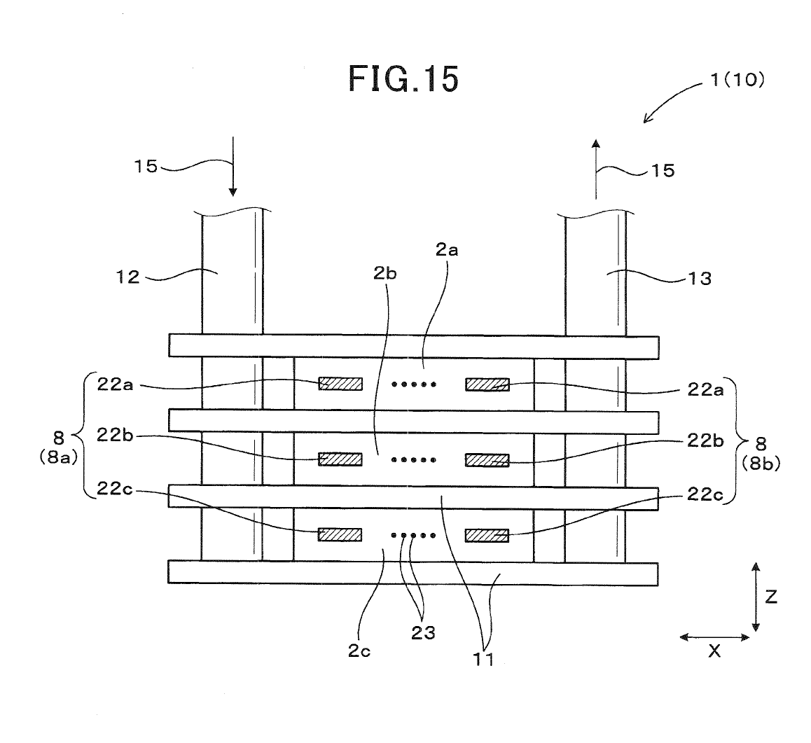

In the present embodiment, the semiconductor modules 2 of a power converter 1 are modified in shape and arrangement. As shown in FIG. 15, the power converter 1 includes three semiconductor modules 2. As in the third embodiment (see FIG. 12), each semiconductor module 2 has two output terminals 22. In contrast to the third embodiment, the three semiconductor modules 2 and cooling elements form a stack 10 along the Z-direction.

The output terminals of the three respective semiconductor modules 2 all protrude in the same direction (e.g., in the Y-direction). One of the two output terminals 22a of a first semiconductor module 2a, one of the two output terminals 22b of a second semiconductor module 2b, and one of the two output terminals 22c of a third semiconductor module 2c form a first output terminal group 8a. The other one of the two output terminals 22a of the second semiconductor module 2a, the other one of the two output terminals 22b of the second semiconductor module 2b, and the other one of the two output terminals 22c of the second semiconductor module 2c form a second output terminal group 8b.

The first output terminal group 8a is disposed adjacent the second output terminal group 8b along the X-direction. More specifically, when viewed from the X-direction, the three terminals 22a-22c of the first output terminal group 8a are disposed on the same side of the power converter 1, and the three terminals 22a-22c of the second output terminal group 8b are disposed on another same side.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A power converter comprising:
a plurality of semiconductor modules each having a body including semiconductor elements, the body being provided with control terminals, a pair of input terminals, and at least two output terminals protruding from the body, wherein the output terminals protruding from the respective bodies of the respective semiconductor modules are grouped into a plurality of output terminal groups each formed of three output terminals belonging to at least two different semiconductor modules; and
a control circuit board electrically connected to the control terminals protruding from the respective bodies of the respective semiconductor modules and configured to turn on and off the respective semiconductor elements of the respective semiconductor modules so as to convert a DC voltage applied to the pair of input terminals of each semiconductor module into a three-phase AC voltage to be outputted from the three output terminals of each output terminal group.

2. The power converter of claim 1, further comprising a plurality of cooling elements that are configured to cool the plurality of semiconductor modules,
wherein the body of each of the plurality of semiconductor modules is quadrilateral plate-shaped,
the plurality of semiconductor modules and the plurality of cooling elements are alternately stacked in a normal direction of a principal surface of the body to form a stack,
the respective output terminals protrude from side surfaces of the respective bodies of the respective semiconductor modules in the same direction,
the at least two output terminals of each of the plurality of semiconductor module are distributed along a width-wise direction that is perpendicular to both the normal direction of the principal surface of the body and the protruding direction of the output terminals, and
the three output terminals of each output terminal group are disposed in close proximity to each other along the width-wise direction.

3. The power converter of claim 2, wherein none of the at least two output terminals protruding from the body of one of the plurality of semiconductor modules overlap any of the at least two output terminals protruding from the body of another adjacent one of the plurality of semiconductor modules when viewed from the normal direction.

4. The power converter of claim 3, wherein the at least two output terminals protruding from the body of one of the plurality of semiconductor modules and the at least two output terminals protruding from the body of another adjacent one of the plurality of semiconductor modules are alternately distributed along the width-wise direction when viewed from the normal direction.

5. The power converter of claim 2, further comprising:
a first current sensor attached to one of the three output terminals forming a first output terminal group and configured to measure a current flowing into the three output terminals of the first output terminal group; and
a second current sensor attached to one of the three output terminals forming a second output terminal group and configured to measure a current flowing into the three output terminals of the second output terminal group,
wherein the output terminal to which the first current sensor is attached and the output terminal to which the second current sensor protrude from the same body of either one of the plurality of semiconductor modules, and the first and second sensors are integrated.

6. The power converter of claim 1, further comprising a plurality of cooling elements that are configured to cool the plurality of semiconductor modules,
wherein the plurality of output terminal groups include a first output terminal group formed of three output terminals electrically connected to a first AC load having a relatively high power consumption, and a second output terminal group formed of three output terminals electrically connected to a second AC load having a relatively low power consumption,
semiconductor elements, of the plurality of semiconductor modules, that feed a three-phase AC voltage to the first AC load via the three output terminals of the first output terminal group are disposed upstream of semiconductor elements, of the plurality of semiconductor modules, that feed a three-phase AC voltage to the second AC load via the three output terminals of the second output terminal group along a coolant flow path of at least one of the cooling elements.

7. The power converter of claim 1, wherein
the body of each of the plurality of semiconductor modules is quadrilateral plate-shaped,
the plurality of semiconductor modules include first and second semiconductor modules each having at least three output terminals and being disposed adjacent each other along a width direction that is perpendicular to a normal direction of a principal surface of the body,
the plurality of output terminal groups include first and second output terminal groups,
the first output terminal group is formed of two of the at least three output terminals of the first semiconductor module and one of the at least three output terminals of the second semiconductor module,
the second output terminal group is formed of one of the at least three output terminals of the first semiconductor module and two of the at least three output terminals of the second semiconductor module,
the three output terminals of the first output terminal group protrude from the respective bodies of the first and second semiconductor modules in the same direction, and the three output terminals of the second output terminal group protrude from the respective bodies of the first and second semiconductor modules in the same direction opposite the direction in which the three output terminals of the first output terminal group protrude.

8. The power converter of claim 1, wherein
the body of each of the plurality of semiconductor modules is quadrilateral plate-shaped,
the plurality of semiconductor modules include first, second, and third semiconductor modules disposed adjacent each other in series in this order along a width direction that is perpendicular to a normal direction of a principal surface of the body,
the plurality of output terminal groups include first and second output terminal groups,
the first output terminal group is formed of two of the at least two output terminals of the first semiconductor module and one of the at least two output terminals of the second semiconductor module,
the second output terminal group is formed of one of the at least two output terminals of the second semiconductor module and two of the at least two output terminals of the third semiconductor module,
the three output terminals of the first output terminal group protrude from the respective bodies of the first and second semiconductor modules in the same direction, and the three output terminals of the second output terminal group protrude from the respective bodies of the second and third semiconductor modules in the same direction as the direction in which the three output terminals of the first output terminal group protrude.

9. The power converter of claim 2, wherein
the plurality of semiconductor modules include first, second, and third semiconductor modules stacked in this order along the normal direction,
the plurality of output terminal groups include first and second output terminal groups,
the first output terminal group is formed of one of the at least two output terminals of the first semiconductor module, one of the at least two output terminals of the second semiconductor module, and one of the at least two output terminals of the third semiconductor module,
the second output terminal group is formed of one of the at least two output terminals of the first semiconductor module, one of the at least two output terminals of the second semiconductor module, and one of the at least two output terminals of the third semiconductor module,
the three output terminals of the first output terminal group are disposed on one side of the stack along the width direction, and the three output terminals of the second output terminal group disposed on the opposite side of the stack along the width direction, and
the three output terminals of the first output terminal group protrude from the respective bodies of the first to third semiconductor modules in the same direction, and the three output terminals of the second output terminal group protrude from the respective bodies of the first to third semiconductor modules in the same direction as the direction in which the three output terminals of the first output terminal group protrude.
